(19) United States
(12) Patent Application Publication
(10) Pub. No.: US 2026/0105928 A1
(43) Pub. Date: Apr. 16, 2026

(54) SYSTEMS AND METHODS FOR FADE CONTROL FOR ARTIFICIALLY GENERATED CONTENT IN A REAL TIME COMMUNICATION BASED ARCHITECTURE

(71) Applicant: Agora Lab, Inc., Santa Clara, CA (US)

(72) Inventors: Hai Guo, Santa Clara, CA (US); Jimeng Zheng, Guangzhou (CN); Bo Wu, Guangzhou (CN); Ziyi Lin, Guangzhou (CN); Sheng Zhong, Santa Clara, CA (US)

(21) Appl. No.: 18/970,121

(22) Filed: Dec. 5, 2024

Related U.S. Application Data
(60) Provisional application No. 63/706,256, filed on Oct. 11, 2024.

(51) Int. Cl. G10L 21/034

(52) U.S. Cl. CPC G10L 21/034

(57) ABSTRACT

Systems and methods for the fading of an audio stream in response to an interruption in a real time communication system is provided. In some embodiments, an audio stream is received from a content generator. The content generator may be a cloud based Artificial Intelligence Generated Content (AIGC) system. A local device to the user then begins playing the audio stream. Then an interruption event is received for the audio stream.

The audio stream is then faded-out. Lastly, a stop response flag is generated, and this flag is provided back to the content generator. It is also possible to fade-in the beginning of the audio stream. Sometimes the audio stream is speech. At the conclusion of the audio stream, if it has not been interrupted, it may also undergo a fade-out process. In some embodiments, the audio stream is generated in response to a query by a user

### CROSS REFERENCE TO RELATED APPLICATIONS

This application claims the benefit and priority of U.S. Application No. 63/706,256, filed Oct. 11, 2024, the contents of which is incorporated herein by reference in its entirety.

### BACKGROUND

The present invention relates in general to the field of audio control for generated content, and more specifically to methods, computer programs and systems for the fade control over speech and other audio generated by Artificial Intelligence (AI) systems. The ability to modulate audio levels based upon speech stage and presence of interruptions leads to a more organic and pleasant user experience.

Recently, artificial intelligence generated content (AIGC) has been gaining more attention and is expanding rapidly. AIGC is a technology based on machine learning and natural language processing that can automatically generate various types of content, including text, images, audio, and more. These contents could be news articles, novels, images, music, and even software code. AIGC systems learn to mimic human creativity by analyzing large amounts of data and text, enabling them to generate high-quality content.

As an important application of AIGC, human-to-machine communication have gained significant popularity and attention across various sectors. This surge can be attributed to advancements in artificial intelligence and natural language processing technologies, which have enabled these systems to understand and generate human-like responses. As businesses and organizations seek to enhance customer engagement, chatbots and virtual assistants have become essential tools for providing instant support and personalized experiences. As an example, an Apple's smart assistant, Siri is widely used in Apple devices, with which users can easily get information or have a human-like conversation.

During human-to-machine communication, when the AI-agent starts speaking, the amplitude of the speech jumps suddenly from zero to a large value, introducing discontinuity. Also, when the user says something to interrupt the AI-agent, the latter would have to stop speaking to further listen to what the user talks and generate response afterwards. Currently, vendors providing AIGC services just simply start and stop playing AIGC generated speech without any transition, which results in discontinuity in speech and bad auditory user experience.

Given that there is great value in the ability to provide AIGC to a user in a manner that is pleasant and with reduced discontinuity in the audio portion of the content, fade control systems and methods are provided.

### SUMMARY

The present systems and methods relate to the control of audio levels, and particularly fade in and out control over AIGC audio. Such systems and methods reduce discontinuity in speech or other audio elements of AIGC generated speech and other audio.

In some embodiments, an audio stream is received from a content generator. The content generator may be a cloud based Artificial Intelligence Generated Content (AIGC) system. A local device to the user then begins playing the audio stream. Then an interruption event is received for the audio stream. The interruption is one of the user speaking, a switch in voice, or when content of the audio stream violates at least one policy. The audio stream is then faded-out over a fading time window. This window may vary between 50 ms to 1second or longer.

Lastly, a stop response flag is generated when an amplitude of the audio stream is below a threshold, and this flag is provided back to the content generator. The threshold may be zero or an amplitude below human hearing. The fading is a change in amplitude that is one of linear, exponential, logarithmic and in accordance with an s-curve. It is also possible to fade-in the beginning of the audio stream. Sometimes the audio stream is speech. At the conclusion of the audio stream, if it has not been interrupted, it may also undergo a fade-out process. In some embodiments, the audio stream is generated in response to a query by a user

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example block diagrams of a system for delivery of Artificial Intelligence Generated Content (AIGC) to a plurality of users, in accordance with some embodiment;

FIG. 2A is an example block diagram showing the system for generating audio with fade control, in accordance with some embodiment;

FIG. 2B is an example block diagram showing an example audio encoding and transmission module, in accordance with some embodiment;

FIG. 2C is an example block diagram showing an example fade control module, in accordance with some embodiment;

FIG. 3 is a flowchart for an example process for the delivery of AIGC with fade control, in accordance with some embodiment; and

FIGS. 4A and 4B are illustrations of computer systems capable of implementing the fade control, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for the generation, transmission and fade control over audio elements. In some embodiments, the disclosure will specifically focus on content that is generated by Artificial Intelligence systems. This Artificial Intelligence Generated Content (AIGC) is a particularly salient use case but is not intended to limit the scope of the present disclosure. Even audio elements that are generated by other means, not associated with an Artificial Intelligence (AI) system may benefit from such systems and methods. Thus, while the disclosure shall focus upon AIGC, and generated audio, subject to an interruption by the user, may apply.

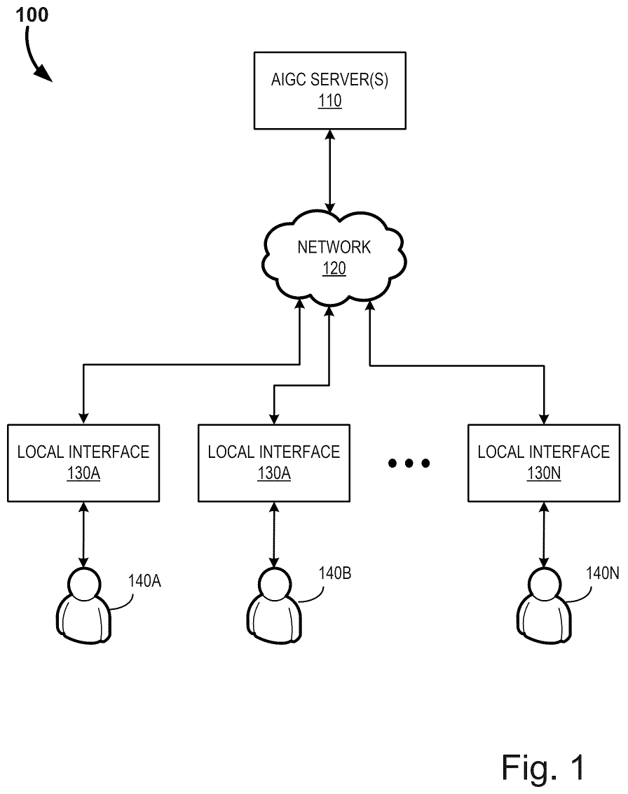

To facilitate discussions, FIG. 1 is an example of a system for delivering AIGC to one or more users 140a-n, shown generally at 100. In this architecture one or more AIGC servers 110 receives input from the users 140a-n via their respective end devices. These end devices may include smart phones, smart speakers, computer systems and the like. Regardless of the form of the end device, they each include an audio local interface 130a-n. These local interfaces may receive input from the respective user 140a-n, and provide the input back to the AIGC server(s) 110 via a network 120. In most cases the network is comprised of a cellular network and/or the internet. However, it is envisioned that the network includes any wide area network (WAN) architecture, including private WAN's, or private local area networks (LANs) in conjunction with private or public WANs.

While a cloud based system is illustrated herein, it is possible, especially as computational powers increase, that the local interface 130a-n may include sufficient computational and data resources to provide AIGC without the need for a cloud connected architecture. Thus, while the present systems and methods will focus upon a cloud derived system, the fade control methods disclosed herein work equally well when the AI content is locally generated.

In an RTC-based (Real-Time Communication) AIGC system, the user's audio is firstly encoded and transmit to the AIGC server 110 via the network 120, then after processing of the system, the response audio will be sent back to the user 140a-n in a streaming manner. Once the user 140a-n interrupts the AI-agent, the system should keep sending the generated audio for a certain time in a “fade-out” manner, which means that the system will avoid immediately stopping sending response back to the user and keeps sending the attenuated version of the response within a certain time and gradually reduce its energy to zero to keep the continuity and enhance user experience. Also, the coding, transmission, decoding and playing module continue working until the system fully stops sending the audio. Once the fading process is done, the AIGC system will get a stop response flag, and the audio encoding and transmission will cease that time.

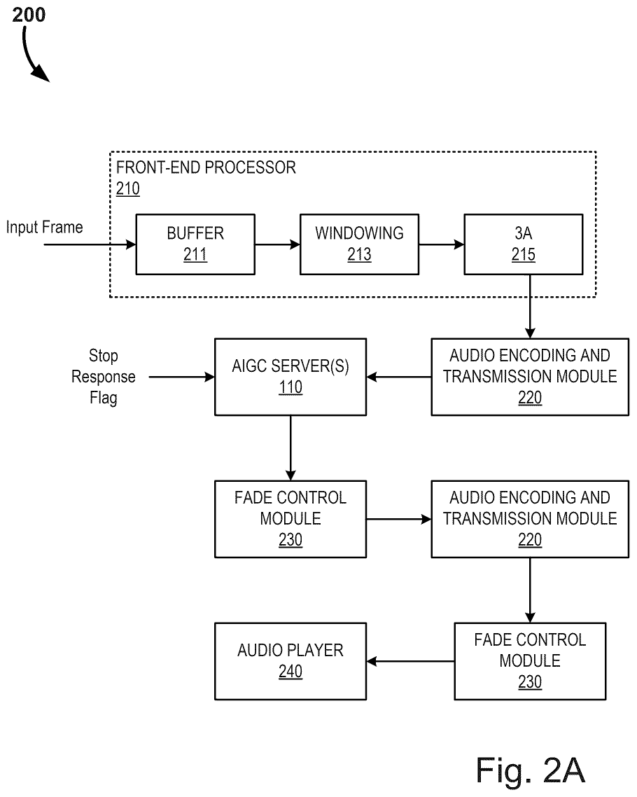

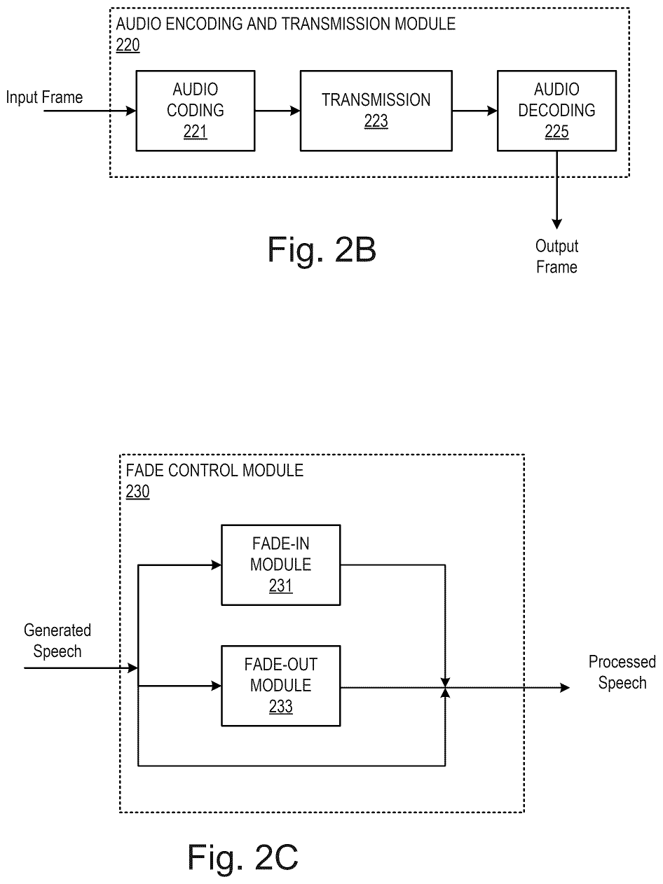

FIG. 2A provides an example block diagram illustrating the overall proposed AIGC application with fade control in RTC system. The proposed system 200 has mainly four components, e.g.. front-end processing 210, AIGC system 110, fade control 230, and audio encoding and transmission pipeline 220.

The front-end processor 210 includes a buffer 211 for buffering the incoming frame, windowing 213 and a 3A system 215. The 3A system 215 is an umbrella component capable of acoustic echo cancellation, acoustic noise reduction and automatic gain control. Front-end processing is performed on the input speech frame to remove interference terms as much as possible.

The audio encoding and transmission system 220 is seen in greater detail in relation to FIG. 2B. This component contains audio coding 221, transmission 223 and audio decoding 225, which illustrates the typical pipeline of audio transmission. The user speech is processed through the audio encoding and transmission system 220 and provided to the AIGC servers 110. The AIGC system 110 processes the user's speech, understands it, and generates response speech to the user. The AIGC system 110 may receive a stop response flag, at any time, caused by an interruption by the user.

The speech (or other generated audio) is then provided to a fade control module 230. A more detailed illustration of the fade control module is provided in relation to FIG. 2C. In the fade control module, there are three paths, which are fade-in 231, fade-out 233, and otherwise path, which stands for “pass” and without doing any modification. The fade-in 231 and fade-out module 233 result in the avoidance of the introduction of discontinuity in the audio, which enhances the user's experience.

There are four circumstances under which the fade control module 230 operates. The first one is that the AIGC system is ready to produce the generated speech. Here, there is a certain moment when the amplitude of the generated speech suddenly jumps from zero to a large value which introduces strong discontinuity and unpleasant auditory experience. In order to mitigate this effect, the fade-in technique may be utilized where the amplitude of the speech gradually increases to its original value. The second is that the user interrupts the AI-agent while it's talking. All vendors providing AIGC services just simply stop playing the generated speech without any transition. What the user experience is that the sound suddenly and unnaturally vanishes. This also introduces a jump from a large value to zero. The fade-out technique applied to eliminate this effect via gradually decreasing the amplitude of the speech to zero. Note that not just the case when the user interrupts the AI-agent's speaking needs the fade-out technique, but also the case when he/she switches it's voice to others or the case that it detects that the content it is generating violates its safety or compliance standards, and more, which indicates that the fade-out technique can be widely used in various circumstances. The third one is when the AIGC system finish speaking, and the case the fade-out technique is applied to eliminate this effect via gradually decreasing the amplitude of the speech to zero. Lastly, while the AIGC system is still generating speech normally, the fade control system will not do anything and the generated speech just simply bypass the system. In the overall flow chart, there are two fade control modules, one placed after the AIGC module and the other placed before audio playing module, where the latter one is necessary, since it ensure that the generated audio is actually faded-in or faded-out.

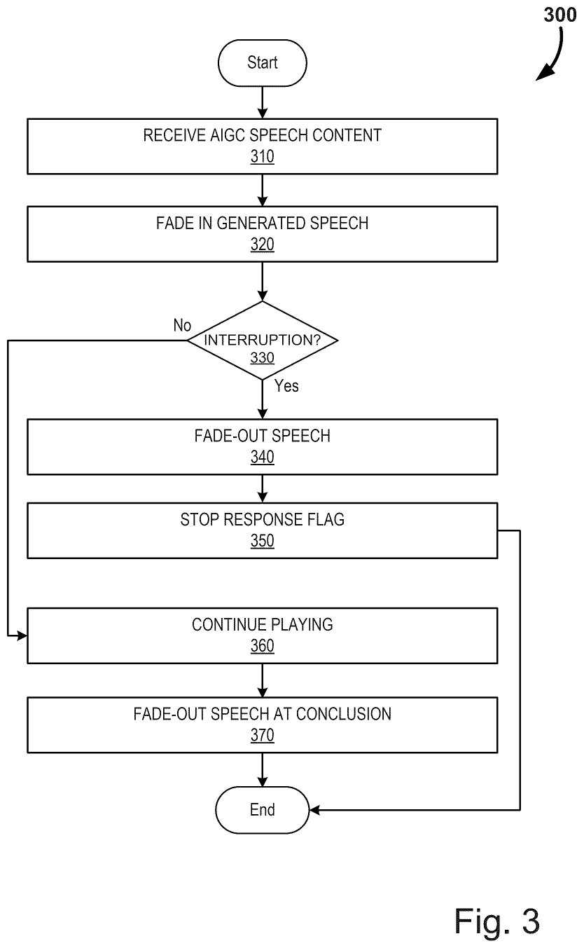

Turning now to FIG. 3, an example flow diagram for the process of fade control in AIGC in real time communication is provided, as seen generally at 300. Initially, a user engages the smart speaker, smart phone, or other interface device. Typically, the user speaks a trigger word which begins the recordation of the user's voice. The user can ask questions or make a request of the AI system. The user's audio undergoes processing by the front-end processor where the recording is buffered. It then undergoes windowing, and then a series of acoustic processing including echo cancellation, noise reduction, automatic gain control and the like. The resulting output frames are then encoded, transmitted, and decoded at the AIGC server. Transmission is usually over the internet or other network as the AIGC server is generally cloud based due to data and computational demands that render local processing impractical.

The AIGC server utilizes machine learning on a depth of models to generate a response to the user query. This response may include audio and additional outputs (e.g., video, links and other web content, pictures and the like). In some embodiments, the audio portion of the resulting output may be initially subjected to fade control. It is then encoded, transmitted and decoded back at the local device to the user, where the speech, or other audio, content is received, as seen at 310. The initial speech, or other audio, is initially faded in from zero amplitude to the maximum amplitude that is being utilized, as seen at 320. Generally, this maximum amplitude is configurable by the user using a volume control. The fading may occur relatively quickly; in some embodiments, fading in can take anywhere from 50 ms to a full second. In some embodiments the fading can take approximately 50 ms, 100 ms, 200 ms, 300 ms, 400 ms, 500 ms, 600 ms, 700 ms, 800 ms, or 900 ms. The term “approximately” generally refers to having a deviation of up to 20% of the stated value. In some embodiments, the fading may be a linear shift in amplitude over the fade-in time window. In alternate embodiments, the fading may be on a logarithmic scale, exponential or according to an s-curve.

The speech continues to play until an interruption by the user, or some other interruption event, is encountered, as seen at 330. If an interruption occurs, the speech (or other audio) is faded out in the inverse manner in which it was faded in, as seen at 340. The length of time the speech fads out may be the same as the fade-in time length or may be a different length of time. Generally, however, the fade-out time is anywhere from 50 ms to a full second. In some embodiments the fading can take approximately 50 ms, 100 ms, 200 ms, 300 ms, 400 ms, 500 ms, 600 ms, 700 ms, 800 ms, or 900 ms.

Once the amplitude of the speech approaches zero (or a volume level imperceptible to the human ear), a stop response flag may be generated and transmitted to the AIGC server to discontinue the generation of content, as seen at 350. This ends the example process.

If, however, no interruption is ever encountered, the system may continue playing the content provided by the AIGC server, as seen at 360, until the content is concluded. Upon conclusion of the content, the system may fade-out the final portion of the speech, as seen at 370. This fading-out of the audio may be performed in an manner substantially similar to what occurs when an interruption event is encountered. This too, ends the example process.

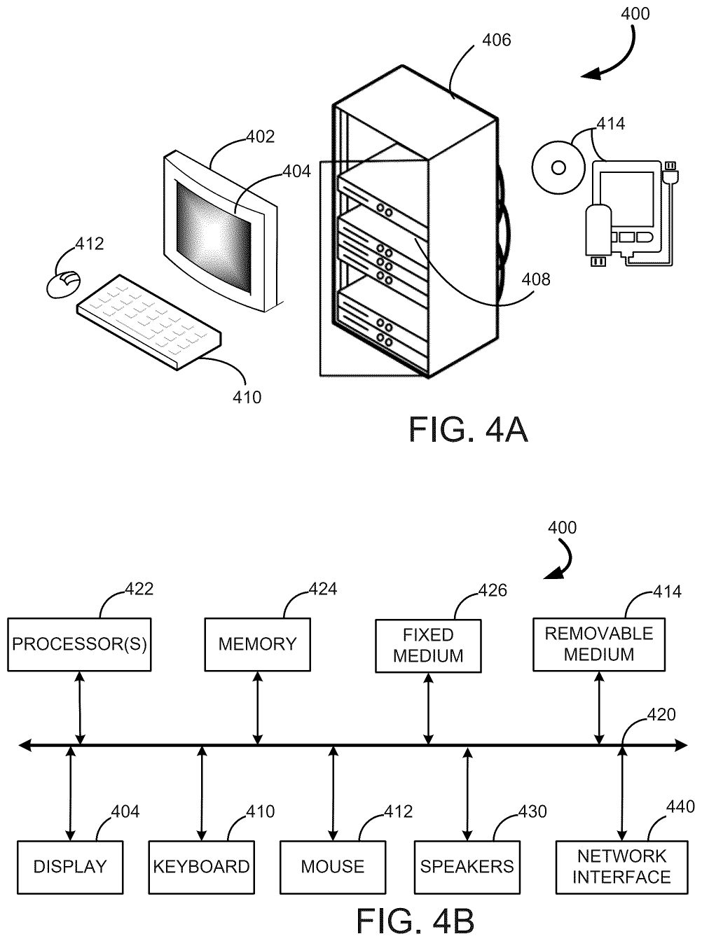

Now that the systems and methods for fade control or artificially generated content has been provided, attention shall now be focused upon apparatuses capable of executing the above functions in real-time. To facilitate this discussion, FIGS. 4A and 4B illustrate a Computer System 400, which is suitable for implementing embodiments of the present invention. FIG. 4A shows one possible physical form of the Computer System 400. Of course, the Computer System 400 may have many physical forms ranging from a printed circuit board, an integrated circuit, and a small handheld device up to a huge supercomputer. Computer system 400 may include a Monitor 402, a Display 404, a Housing 406, server blades including one or more storage Drives 408, a Keyboard 410, and a Mouse 412. Medium 414 is a computer-readable medium used to transfer data to and from Computer System 400. FIG. 4B is an example of a block diagram for Computer System 400. Attached to System Bus 420 are a wide variety of subsystems. Processor(s) 422 (also referred to as central processing units, or CPUs) are coupled to storage devices, including Memory 424. Memory 424 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 426 may also be coupled bi-directionally to the Processor 422; it provides additional data storage capacity and may also include any of the computer-readable media described below. Fixed Medium 426 may be used to store programs, data, and the like and is typically a secondary storage medium (such as a hard disk) that is slower than primary storage. It will be appreciated that the information retained within Fixed Medium 426 may, in appropriate cases, be incorporated in standard fashion as virtual memory in Memory 424. Removable Medium 414 may take the form of any of the computer-readable media described below.

Processor 422 is also coupled to a variety of input/output devices, such as Display 404, Keyboard 410, Mouse 412 and Speakers 430. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 422 optionally may be coupled to another computer or telecommunications network using Network Interface 440. With such a Network Interface 440, it is contemplated that the Processor 422 might receive information from the network, or might output information to the network in the course of performing the above-described fade control methods. Furthermore, method embodiments of the present invention may execute solely upon Processor 422 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 400 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a real time communication system, a computerized method for fade control for generated audio comprising:
receiving an audio stream from a content generator;
beginning playing the audio stream;
receiving an interruption event for the audio stream;
fading-out the audio stream over a fading time window;
generating a stop response flag when an amplitude of the audio stream is below a threshold; and
transmitting the stop response flag to the content generator.

2. The method of claim 1, wherein the content generator is an Artificial Intelligence Generated Content (AIGC) system.

3. The method of claim 1, wherein the threshold is zero.

4. The method of claim 1, wherein the threshold is an amplitude below human hearing.

5. The method of claim 1, wherein the fading time window is between 50ms and 1s.

6. The method of claim 1, wherein the fading is a change in amplitude that is one of linear, exponential, logarithmic and in accordance with an s-curve.

7. The method of claim 1, further comprising fading in the beginning of the audio stream.

8. The method of claim 1, wherein the audio stream is speech.

9. The method of claim 1, wherein the audio stream is generated in response to a query by a user.

10. The method of claim 1, wherein the interruption is one of the user speaking, a switch in voice, or when content of the audio stream violates at least one policy.

11. A real time communication system for fade control for generated audio comprising:
an encoder system configured to receive an audio stream from a content generator;
a local device configured to begin playing the audio stream, and receive an interruption event for the audio stream;
a fade control module in the local device configured to fade-out the audio stream over a fading time window, and generating a stop response flag when an amplitude of the audio stream is below a threshold; and
the encoder system further configured to transmit the stop response flag to the content generator.

12. The system of claim 11, wherein the content generator is an Artificial Intelligence Generated Content (AIGC) system.

13. The system of claim 11, wherein the threshold is zero.

14. The system of claim 11, wherein the threshold is an amplitude below human hearing.

15. The system of claim 11, wherein the fading time window is between 50ms and 1 s.

16. The system of claim 11, wherein the fading is a change in amplitude that is one of linear, exponential, logarithmic and in accordance with an s-curve.

17. The system of claim 11, further comprising fading in the beginning of the audio stream.

18. The system of claim 11, wherein the audio stream is speech.

19. The system of claim 11, wherein the audio stream is generated in response to a query by a user.

20. The system of claim 11, wherein the interruption is one of the user speaking, a switch in voice, or when content of the audio stream violates at least one policy.
